(19) United States
(12) Patent Application Publication
(10) Pub. No.: US 2007/0094687 A1
(43) Pub. Date: Apr. 26, 2007

(54) Method for selective advertisement recording and playback

(76) Inventor: Michael Russell, Boca Raton, FL (US)

Correspondence Address: Ober|Kaler, 120 East Baltimore Street, Baltimore, MD, 21202, US

(21) Appl. No.: 11/584,753

(22) Filed: Oct. 20, 2006

Related U.S. Application Data
(60) Provisional application No. 60/729,019, filed on Oct. 21, 2005.

(51) Int. Cl. G06F 3/00; H04N 5/445; G06F 13/00; H04N 7/025; H04N 7/10

(52) U.S. Cl. 725/46; 725/58; 725/35

(57) ABSTRACT

A system and method for controlling the displaying and recording of advertisements that allows viewers to view the advertisements embedded in content, separate from content, or not at all. The system employs a set-top box loaded with a hierarchical menu program to allow viewers to choose the display mode for advertisements. The menu of advertising display choices includes “Normal content with Embedded Advertising”, “Filtered content with No Embedded Advertising”, and “Standalone Advertising”. The viewer makes their choice, and incoming advertisement clips, content and control signals are recorded and stored in separate storage areas. Upon demand, they are recalled, mixed, and displayed with advertisements mixed in at the prescribed instances during the content in accordance with the menu choices. In this manner broadcast viewers have more control over the displaying and recording of advertisements.

### CROSS-REFERENCE TO RELATED APPLICATIONS

The present application derives priority from U.S. provisional application No. 60/729,019 filed 21 Oct. 2005.

### BACKGROUND OF THE INVENTION

1. Field of the Invention

The present invention relates generally to personal video recorders (PVRs) and, more particularly, to a system and method for controlling the displaying and recording of advertisements that allows viewers to view the advertisements embedded in content, separate from content, or not at all.

2. Description of the Background

Many broadcasters now transmit in digital format. For example, Digital Satellite System (DSS), Digital Broadcast Services (DBS), and Advanced Television Standards Committee (ATSC) program streams are digitally formatted pursuant to the well known MPEG-2 standard. This standard allows multiple programs, with different video and audio feeds, multiplexed in a transport stream traversing a single transmission channel. The broadcast may then be decoded and extracted by a digital TV receiver.

With the advent of digital TV, Digital Video Recorders (DVRs) have followed, including the Tivo® system which records video content onto a storage medium such as a hard disk that is easily accessible and reusable. The introduction of DVRs has changed the broadcast industry. They give viewers an unprecedented amount of control over how the viewer watches television programs. For example, many DVRs have built-in trick mode functionality (e.g., pause, fast forward, rewind, skip ahead, or skip back functionality) that provides the viewer with the ability to bypass commercials. Viewers enjoy the additional control, and broadcasters are seeking ways to provide like control from their end.

Stand alone DVRs (e.g., TiVo) and some cable television systems are providing value-added services in addition to analog broadcast content. In addition to supporting traditional analog broadcast video functionality, cable providers now offer digital set-top boxes which support an increasing number of two-way digital services such as video-on-demand. A set-top box is typically connected to a cable or satellite television network and includes hardware and software necessary to provide various services and functionality. The software executed by a set-top box is downloaded and/or updated via the cable television network.

Currently, these set-top boxes and DVRs only offer trick-mode functionality that allows viewers to skip or fast-forward through commercials. Many viewers would prefer to have a choice as to whether to skip the commercials, or simply resequence them in order to view them all at once after the normal program content. All set-top boxes and DVRs provide graphical menu systems that allow viewers to specify which content to watch and/or record. It would be greatly advantageous to provide an improved method of menu selection of advertisements which gives greater control over the modes for displaying advertisements, and which allows viewers to request and receive additional information on specific brands such as informational e-mails or hard copy brochures. The public- or user-friendliness of the menu system should include the on-line ability to upload and view program audio/video content and, where desired, to view and/or record the content to the user's PVR with advertisements displayed according to user-preference.

Applicants are not aware of any existing methods that provide the foregoing capabilities and benefits.

### SUMMARY OF THE INVENTION

It is, therefore, an object of the present invention to allow a broadcast viewer to have a menu selection of advertisements which gives greater control over the modes for displaying advertisements, and which allows viewers to request and receive additional information on specific brands such as informational Emails or hard copy brochures.

It is another object to provide an on-line ability to upload and view program audio/video content and, where desired, to view and/or record the content to the user's PVR with advertisements displayed according to user-preference.

In accordance with the above objects, the present invention is a system and method for controlling the displaying and recording of advertisements. The system employs a set-top box loaded with a hierarchical menu program to allow viewers to choose the display mode for advertisements. The menu of advertising display choices include any from among the group of “Normal content with Embedded Advertising”, “Filtered content with No Embedded Advertising”, and “Standalone Advertising. The viewer makes their choice, and incoming advertisement clips, content and control signals are recorded and stored in separate storage areas Upon demand, they are recalled, mixed, and displayed with advertisements mixed in at the prescribed instances during the content in accordance with the menu choices. In this manner broadcast viewers have control over the displaying and recording of advertisements, and can view advertisements embedded in content, separate from content, or not at all.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a block diagram of the a bidirectional set-top box 10 according to one embodiment of the present invention.

FIG. 2 is a flow chart illustrating the menu selection process of the present invention.

### DETAILED DESCRIPTION OF THE PREFERRED EMBODIMENT

In accordance with the present invention, a system and method are shown for providing broadcast viewers with a menu selection of advertisements that gives greater control over the recording of TV advertisements, and which allows viewers to request and receive additional information on specific brands such as informational Emails or hard copy brochures. The viewer also has the ability to upload and view program audio/video content and, where desired, to view and/or record the content to the user's personal video recorder (PVR) with advertisements displayed according to user-preference.

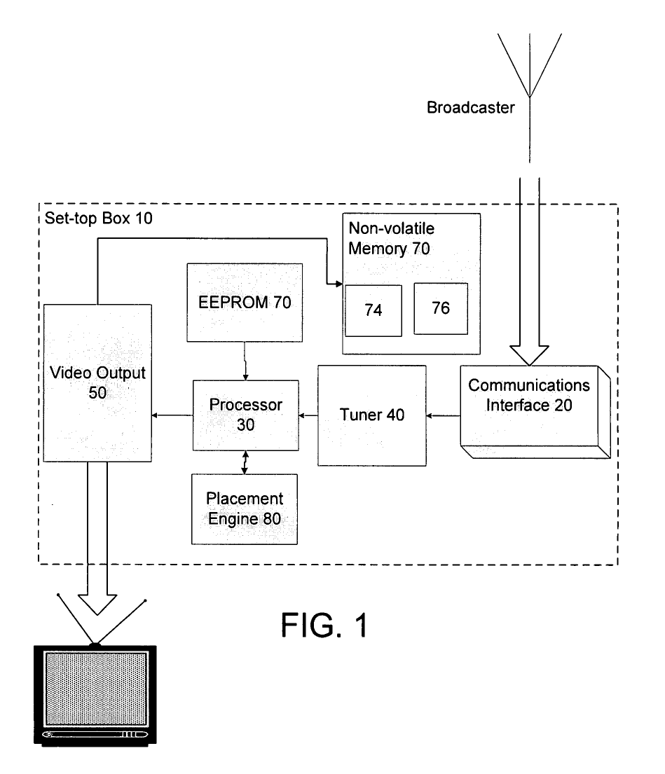

As show in the block diagram of FIG. 1, the present method as herein described employs a bidirectional set-top box 10 for receiving signals (video, audio and/or other data) from the broadcaster and for communicating menu choices thereto.

The system also requires an established program delivery head-end (not shown) which may be a conventional digital cable or satellite television system capable of packaging program content and control information in the form of digital data, and for combining/multiplexing, encoding, compressing and transmitting digital signals for transmission to home set top boxes 10 (to be described) located in each subscriber's home over the cable system. Although cable or satellite systems are the most prevalent transmission media to the home, telephone lines, cellular networks, fiberoptics, and other technology can be used for transmitting interchangeably.

In combining/multiplexing the content, the head end packages the content and creates a program control information signal to be delivered with the program package to the set top box 10. The program control information signal contains a description of the contents of the program package, and menu commands to be sent to the set top box 10, and other information relevant to the signal transmission.

Referring back to the block diagram of FIG. 1, the set-top box 10 has a communications interface 20 for transmitting and receiving signals (video, audio and/or other data) from the broadcaster, a processor 30 for controlling operations of the set-top box 10, a tuner 40 for tuning to a particular television channel to be displayed, a video output 50 coupled to a television, and EPROM memory 60 storing resident software for providing a graphical user-interface on the television to allow viewers to enter user inputs or commands to the processor. The set-top box 10 also has non-volatile memory 70 that is subdivided into advertisement storage 74 for storing advertisement clips or advertisement media streams, and content storage 76 for storing broadcast programming content. The memory 70 may incorporate electronic, magnetic, optical, and/or other types of storage media.

The graphical user-interface contained in memory 60 and displayed on the television allows viewers to, among other controls, preselect their desired advertising viewing format. Preferably, a hierarchical menu is provided allowing a first-level menu of Main TV Programming Menu/Setup/Preferences to give control over content, allowing selection of normal, pay-per view, etc.

Next, a second-level menu of TV Advertising Programming Menu/Setup/Preferences is provided to give control over advertising content, allowing selection of: 1) Normal content with Embedded Advertising; 2) Filtered content with No Embedded Advertising; 3) Standalone Advertising (Separate Review); 4) Menu Selection of Advertising Brands Viewer Would Like To Receive Informational E-Mails/Hard Copy Brochures From.

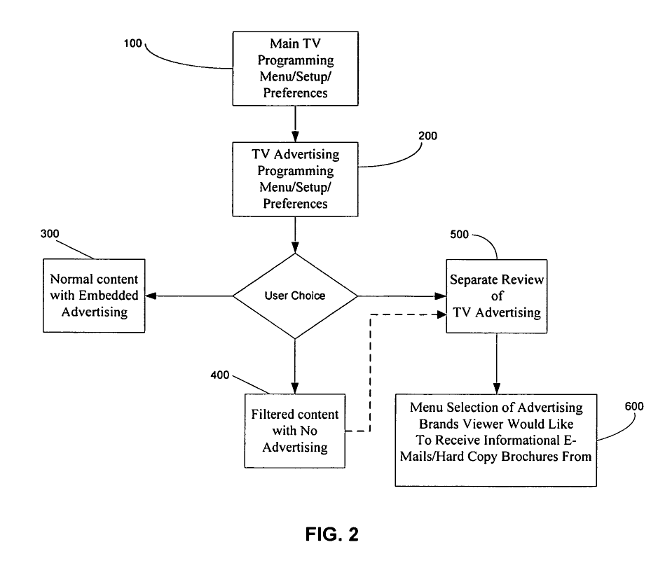

As noted above, the communications interface 20 of set-top box 10 interacts directly with television terminals or with network controllers located at cable headend, and decodes and separates content from the program control information signal to be delivered with the program package to the set top box 10. The program control information signal includes identifiers that identify program content and advertisements, and distinguish the two. Once the viewer has programmed the hierarchical menu in memory 60, this tells the processor 30 how to control operations of the set-top box 10 and display content and advertising. Display of content follows the menu pursuant to the flow chart of FIG. 2. At step 100, the viewer programs the TV Programming Menu/Setup/Preferences. At step 200, the viewer programs the Advertising Programming Menu/Setup/Preferences. If the user chooses at step 300 “Normal content with Embedded Advertising”, content is displayed normally with intermittent advertisements. If the user chooses at step 400 “Filtered content with No Embedded Advertising”, advertising is not displayed at all and content is displayed uninterrupted. If the user chooses at step 500 “Standalone Advertising (Separate Review)” the advertising that was omitted at step 400 is displayed continuously with no program content. In this latter case, the user may proceed to another hierarchical menu at step 600 which allows selection of specific brands advertised at step 500 and for which the viewer would like to receive informational e-mails/hard copy brochures from the advertiser. These requests are forwarded directly to the various advertisers for fulfillment.

The advertisement clips, content and control signals may be transmitted as discrete packets to the set-top box 10 and the clips and content may be stored separately in advertisement storage 74 and content storage 76. In this case, the set top box 10 also requires an advertisement placement engine 80 to recall, mix, and display the advertisements at the prescribed instances during display of the content. One skilled in the art will understand that the advertisement clips, content and control signals may alternatively be stored at the cable head-end and mixed there, for transmission and display to the set-top box 10.

The set top box 10 then converts the mixed and compiled program signal to an analog NTSC signal to enable the subscriber to view the selected program on the TV and/or to record the program signal to storage.

It is noteworthy that the control program stored in memory 70 is provided with a default or normal setting, which is preferably “Standalone Advertising (Separate Review)”. This mode provides distinct advantages if, for instance, the user wants to separately record all the commercials of the Super Bowl.

It should now be apparent that the above-described system and method gives broadcast viewers greater control over the modes for displaying and recording advertisements, and allows viewers to request and receive additional information on specific brands such as informational Emails or hard copy brochures.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth herein.

We claim:

1. A system for selective recording and playback of advertisements comprising:
a broadcaster for broadcasting advertisement clips, television content, and control signals;
a television;
a set-top box including a communications interface to transmit and receive signals from said broadcaster, a processor to control operations of said set-top box, a television tuner, a video output coupled to said television, a first memory for storing resident software to provide a graphical-user interface on said television, a second memory for storing advertisement clips received from said broadcaster, a third memory for storing television content received from said broadcaster, and an advertisement placement engine to recall, mix, and display said television content, and said advertisements clips at prescribed instances during display of said television content; and
a cable head-end to transmit signals from said broadcaster to said communications interface of said set top box.

2. A system for selective advertisement recording and playback according to claim 1, said cable head-end comprising a digital cable system.

3. A system for selective advertisement recording and playback according to claim 1, said cable head-end comprising a satellite television system.

4. A system for selective advertisement recording and playback according to claim 1, said graphical-user interface comprising a menu to preselect desired advertising viewing format.

5. A system for selective advertisement recording and playback according to claim 1, said menu comprising a hierarchical menu including a first-level menu and a second-level menu.

6. A system for selective advertisement recording and playback according to claim 1, said first-level menu comprising a main television programming menu to give control over content and allow selection of normal or pay-per view programming.

7. A system for selective advertisement recording and playback according to claim 1, said second-level menu comprising television advertising programming to allow selection of normal content with embedded advertising, filtered content without embedded advertising, or standalone advertising, and selection of advertising brands viewer would like to receive information from.

8. A method for controlling the displaying and recording of advertisements, comprising the steps of:
providing a menu of advertising display choices to a viewer, including any one from among the group of “Normal content with Embedded Advertising”, “Filtered content with No Embedded Advertising”, and “Standalone Advertising”;
storing advertisement clips, content and control signals in separate storage areas; and
recalling, mixing, and displaying the advertisements at the prescribed instances during the content in accordance with said menu choices;
whereby broadcast viewers have control over the displaying and recording of advertisements, and can view advertisements embedded in content, separate from content, or not at all.

9. A method for controlling the displaying and recording of advertisements according to claim 8, said display choice of “Normal content with Embedded Advertising” comprising normal display of television program content with intermittent advertisements.

10. A method for controlling the displaying and recording of advertisements according to claim 8, said display choice of “Filtered content with No Embedded Advertising” comprising television program content with omitted advertising.

11. A method for controlling the displaying and recording of advertisements according to claim 9, said display choice of “Standalone Advertising” comprising said omitted advertising displayed continuously.

12. A method for controlling the displaying and recording of advertisements according to claim 11, further comprising a step of providing a menu of brands advertised in said display choice of “Standalone Advertising” allowing viewer to select a brand they would like to receive informational material about, wherein said step of providing a menu of brands advertised in display choice of “Standalone Advertising” precedes said step of storing advertisement clips, content and control signals in separate storage areas.

13. A method for controlling the displaying and recording of advertisements according to claim 8, said step of storing advertisement clips, content and control signals in separate storage areas further comprising storing said clips in advertisement storage and storing said content in content storage.

14. A system for selective recording and playback of advertisements comprising:
a broadcaster;
a television;
a set-top box including a communications interface to transmit and receive signals from said broadcaster, a processor to control operations of said set-top box, a tuner, a video output coupled to said television, EPROM memory comprising software to provide a graphical-user interface on said television, non-volatile memory comprising advertisement storage and content storage, and an advertisement placement engine to recall, mix, and display said advertisements at prescribed instances during displays of television program content; and
a cable head-end to transmit signals to said communications interface of said set top box.

15. A system for selective advertisement recording and playback according to claim 14, said cable head-end comprising a digital cable system.

16. A system for selective advertisement recording and playback according to claim 14, said cable head-end comprising a satellite television system.

17. A system for selective advertisement recording and playback according to claim 14, said graphical-user interface comprising a menu to preselect desired advertising viewing format.

18. A system for selective advertisement recording and playback according to claim 14, said menu comprising a hierarchical menu including a first-level menu and a second-level menu.

19. A system for selective advertisement recording and playback according to claim 14, said first-level menu comprising a main television programming menu to give control over content and allow selection of normal or pay-per view programming.

20. A system for selective advertisement recording and playback according to claim 14, said second-level menu comprising television advertising programming to allow selection of normal content with embedded advertising, filtered content without embedded advertising, or standalone advertising, and selection of advertising brands viewer would like to receive information from.
